(19) United States
(12) Patent Application Publication
(10) Pub. No.: US 2007/0282649 A1
(43) Pub. Date: Dec. 6, 2007

(54) Method, system and computer program product for improving information technology service resiliency

(75) Inventors: Larry Earl Davis, St. Louis, MO (US); Milton H.Hernandez Moreno, Tenafly, NJ (US); Prashant Pradhan, Mamaroneck, NY (US); Debanjan Saha, Mohegan Lake, NY (US); Anees Shaikh, Yorktown Heights, NY (US)

Correspondence Address: HARRINGTON & SMITH, PC, 4 RESEARCH DRIVE, SHELTON, CT, 06484-6212, US

(73) Assignee: International Business Machines Corporation

(21) Appl. No.: 11/446,533

(22) Filed: Jun. 2, 2006

(51) Int. Cl. G06F 9/44

(52) U.S. Cl. 705/7

(57) ABSTRACT

A method is provided. The method includes the steps of: generating a model of an information technology process, wherein the process comprises a plurality of process steps and wherein the model identifies resources associated with the process; identifying dependencies on the resources for at least one process step of the plurality of process steps; perturbing the model; assessing an impact of the perturbation on the model; and reducing the impact of the perturbation on the model by utilizing at least one remedial action.

### TECHNICAL FIELD

The teachings in accordance with the exemplary embodiments of this invention relate generally to information technology (IT) processes and, more specifically, relate to assessing and improving the resiliency of IT processes.

### BACKGROUND

IT services are evolving toward a model in which customer systems are managed seamlessly from anywhere in the world to provide the best, most cost-efficient service to any customer worldwide. New global delivery centers enable this level of agility. However, to fully take advantage of this flexibility, an IT process should have a high degree of resiliency to failures and degradation or unavailability of resources in all aspects of the service delivery, from systems and network infrastructure to delivery processes to the technical specialists involved. Prior to this invention, these needs were not adequately addressed.

### SUMMARY

In an exemplary aspect of the invention, a method is provided. The method includes the steps of: generating a model of an information technology process, wherein the process comprises a plurality of process steps and wherein the model identifies resources associated with the process; identifying dependencies on the resources for at least one process step of the plurality of process steps; perturbing the model; assessing an impact of the perturbation on the model; and reducing the impact of the perturbation on the model by utilizing at least one remedial action.

The process may be modeled as a workflow. The method may further include an intermediary step of characterizing at least one normal operating range for the process in terms of at least one metric. The resources may comprise at least one of infrastructure, other processes, people, and skill sets. Perturbing the model may comprise degrading at least one resource or making at least one resource unavailable. The at least one remedial action may comprise replicating at least one resource or modifying the process. At least one of the steps of the method may be implemented on a computer system. The method may further comprise updating the model in response to reducing the impact of the perturbation on the model. The method may further comprise changing the process in response to reducing the impact of the perturbation on the model.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 shows a flowchart illustrating one non-limiting example of a method for practicing the exemplary embodiments of this invention;

FIG. 2 shows a flowchart illustrating another non-limiting example of a method for practicing the exemplary embodiments of this invention;

FIG. 3 depicts a data processing system and user interface suitable for implementing exemplary embodiments of the invention;

FIG. 4 illustrates an exemplary system utilizing a web-based tool in accordance with the exemplary embodiments of the invention;

FIG. 5 depicts the dependency representation of FIG. 4;

FIG. 6 depicts the skills map of FIG. 4;

FIG. 7 depicts a model of a system 100 in accordance with the exemplary embodiments of the invention;

FIG. 8 depicts a scenario in which a site hosting a managing system goes down;

FIG. 9 illustrates a scenario in which a skill set becomes unavailable; and

FIG. 10 provides an additional illustration of the methodology employed in practicing the exemplary embodiments of the invention.

### DETAILED DESCRIPTION

As referred to herein, a process is a structured collection of related activities aimed at reaching a desired outcome (e.g. goal). “Sustaining Operational Resiliency: A Process Improvement Approach to Security Management,” Richard A. Caralli, Section 4.1, Carnegie Mellon Software Engineering Institute Networked Systems Survivability Program, April 2006. Furthermore, as referred to herein, workflow is a defined series of tasks within a system to produce a final outcome. As referred to herein, resiliency is considered to be the ability of a process to adapt to risks that affect the core operational capacities (e.g. business processes, systems and technology, people) in the pursuit of goal achievement and mission viability. See Caralli, Section 1.2. A global delivery center (GDC) is a business center from which an IT process or system is managed, serviced, and/or delivered. GDCs are often utilized in an international context to provide global management or servicing.

Although systematic assessment and remediation methodologies exist for process resiliency in other domains, such as chemical or manufacturing processes, no such methodology exists for IT processes. Furthermore, in other domains resiliency is often characterized by the amount of effort (e.g. “control effort”) required to withstand process disturbances. Such a characterization does not readily apply to IT processes and/or global IT service delivery environments.

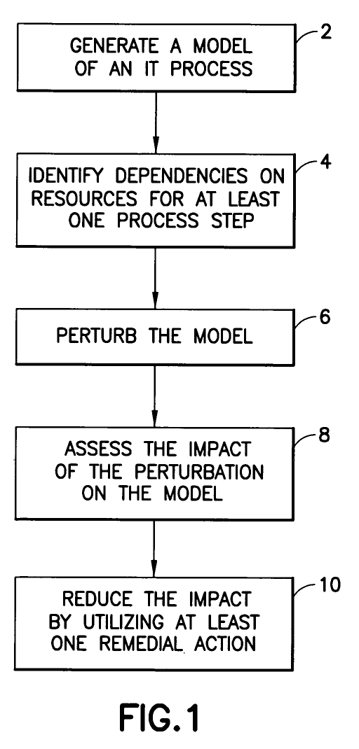

Exemplary embodiments of the invention describe a methodology for assessing the resiliency of an IT process and resolving identified resiliency gaps. FIG. 1 shows a flowchart illustrating one non-limiting example of a method for practicing the exemplary embodiments of this invention. The method includes the following steps. In box 2, a model of an IT process is generated. The process includes a plurality of process steps and the model identifies resources associated with the process. The process may be modeled as a workflow, as a non-limiting example. The model may be annotated with data and resource bindings using standard tools such as the WebSphere® Business Integrator modeler, as a non-limiting example. In generating the model of the IT process, it may be useful to characterize a normal operating range for the process in terms of performance and/or fault tolerance metrics, as non-limiting examples. Further non-limiting examples of such metrics include turnaround time, variability, labor hours spent, and availability expressed as a probability.

In box 4, the resources are identified upon which at least one process step of the plurality of process steps is dependent. In identifying the dependencies of the at least one process step, it may be useful to generate a list of all dependencies, such as generating a dependency representation, as a non-limiting example. A process dependency representation may be generated from the process model or from an Information Technology Infrastructure Library (ITIL®) definition of the process, as non-limiting examples. The identified resources may comprise infrastructure (e.g. tools, servers, applications), other processes (e.g. related processes upon which the modeled process is dependent), and/or people (e.g. specialized skill sets people possess, administrative access, administrative oversight, management skills), as non-limiting examples.

ITIL® is a widely accepted approach to IT service management. ITIL® provides a cohesive set of best practice, drawn from the public and private sectors internationally. ITIL® outlines an extensive set of management procedures that are intended to support businesses in achieving both quality and value for money in IT operations. These procedures are supplier independent and have been developed to provide guidance across the breadth of IT infrastructure, development, and operations.

In box 6, the model is perturbed. The perturbation may be accomplished by degrading or removing at least one resource, as non-limiting examples. One non-limiting example of degrading a resource is a reduction in network bandwidth. Non-limiting examples of removing a resource include a network connection failure (e.g. a server going offline, a communication line disrupted by a natural disaster) and the unavailability of a specific individual (e.g. network manager out of office due to illness).

In box 8, the impact of the perturbation on the model is assessed. The impact of the perturbation may be assessed utilizing a relative scale (e.g. as having a high or low impact), a numerical scale (e.g. estimated percentage degradation in process performance), or using no scale (e.g. estimated effect on the overall goal of the process), as non-limiting examples. Generally, processes that suffer a relatively high impact from perturbations are considered to have poor resiliency.

The steps of perturbing the model and assessing the impact of the perturbation may also be referred to as a sensitivity analysis. The sensitivity analysis ascertains how sensitive the process is to disruptions that may occur in the operation of the process.

In box 10, the impact of the perturbation on the model is reduced by utilizing at least one remedial action. Non-limiting examples of a remedial action include replicating resources contributing to high impact (e.g. ensuring adequate redundancy of high impact resources) and modifying the process to reduce the effect of the impact (e.g. using knowledge bases to reduce dependence on critical skills). The goal is to utilize the previous assessment to improve the overall functionality of the process in the face of adverse disturbances. As a non-limiting example, the at least one remedial action may be employed in advance of an actual problem to refine the process model in preparation for or anticipation of potential disturbances. In such an example, as non-limiting examples, the model may be updated with a new representation to reflect the refinements to its operation and/or the process may be revised in consideration of the assessment. As an additional non-limiting example, the at least one remedial action may be employed during an actual disturbance to address the impact the disturbance is having on the functionality of the process.

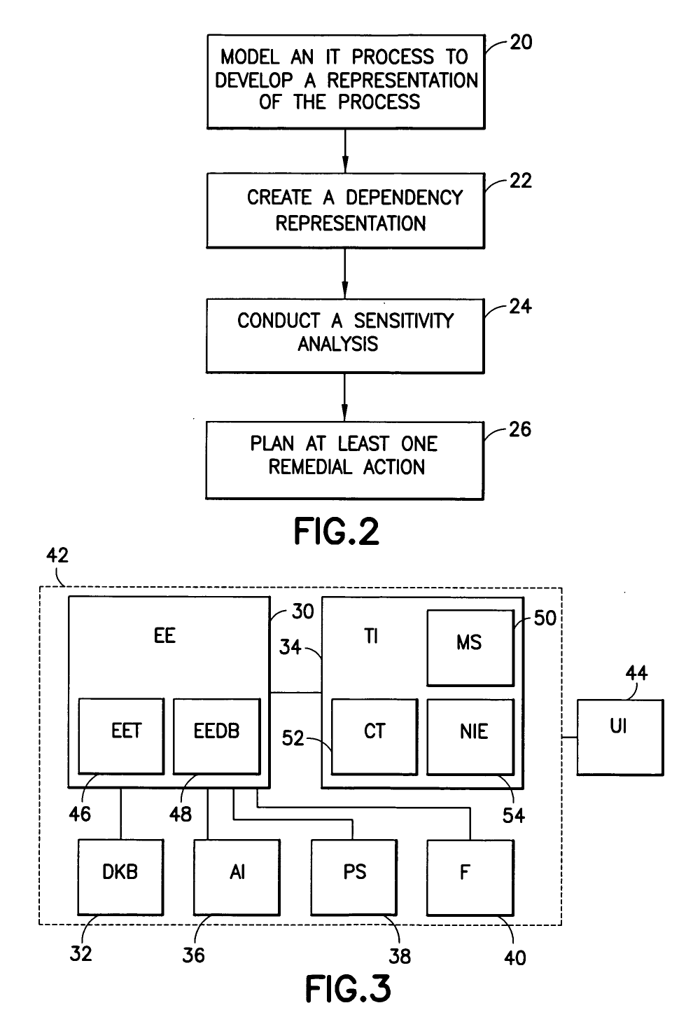

FIG. 2 shows a flowchart illustrating another non-limiting example of a method for practicing the exemplary embodiments of this invention. The method is for improving IT process resiliency and includes the following steps. In box 20, an IT process is modeled to develop a representation of the process. In box 22, a dependency representation is created from the representation. In box 24, a sensitivity analysis is conducted based upon the dependency representation. The sensitivity analysis is utilized to determine the impact of any partial or whole unavailability of resources. In box 26, at least one remedial action is planned. The at least one remedial action is employed to resolve or reduce the impact of the partial or whole unavailability of resources.

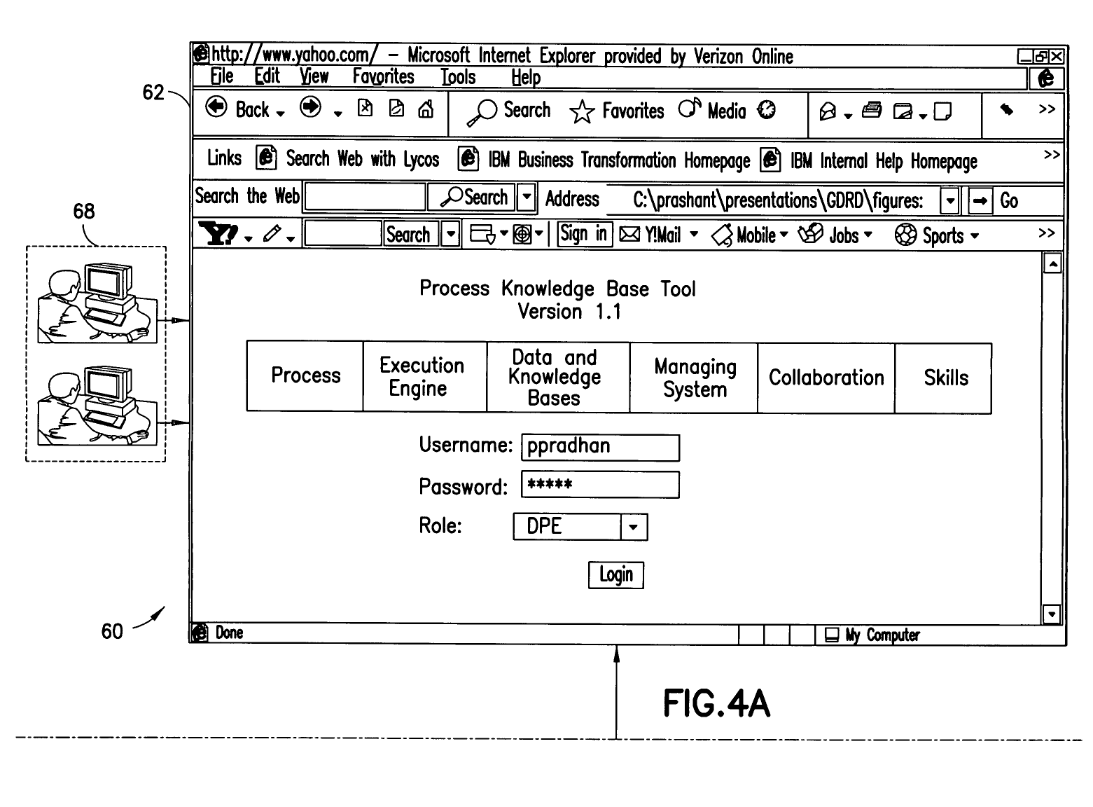

The resiliency of a process may depend on a set of entities (e.g. resources). As shown in FIG. 3, this set of entities may include: a process execution engine (EE) 30; at least one data and/or knowledge base (DKB) 32; a tools infrastructure (TI) 34; an access interface (AI) 36 for providing access to managed IT infrastructure, management tools, and managing tools; people and skills (PS) 38; and facilities (F) 40, as non-limiting examples. In the exemplary embodiment of FIG. 3, the set of entities comprises a data processing system 42. The data processing system 42 is coupled to a user interface (UI) 44. The user interface 44 may comprise a graphical user interface, as a non-limiting example.

For a given process, the EE 30 comprises tools (EET) 46 and databases (EEDB) 48 that maintain state about the progress of the process and the current state of the artifacts and/or objects being processed (e.g. a problem ticket, a change request). If the EE 30 fails, the current state of these artifacts is lost, as well as the progress of the process. If, for example, the process was initiated through a service request, it may not be possible to resume the process unless the service request is somehow re-generated. The problem may reoccur as an escalation, or the time spent in recovering may lead to significant losses for the customer (for example, a security hole that was not closed, a problem request for a production transaction processing server). Once the tools 46 and databases 48 have been identified, it may be desirable to analyze whether they are in a redundant configuration that allows recovery of the current state in the event of a failure. The urgency and/or cost case for creating a redundant configuration can be determined based on the impacted processes that share the same process execution infrastructure.

Any data and/or knowledge base 32 that is being used to drive a process preferably should be identified. Non-limiting examples of such data and/or knowledge bases 32 include a customer server inventory, a routing table that maps problem tickets of specific accounts and applications to ticket queues, or a knowledge base that maps specific kinds of errors to their resolution steps. To assess the potential impact of a loss of this information, a scenario may be considered in which a data and/or knowledge base that contains customer server inventory and application deployment information is lost, thus impeding any change approval or patch application processes. Similarly, another scenario may be considered in which the knowledge base containing the set of all problems ever solved by a resolver group is lost, translating to a loss of time in terms of having to re-diagnose problems that have been seen and solved before. Once identified, it may be desirable to ensure that the data and/or knowledge bases 32 are in a redundant configuration, or at least backed up.

The tools infrastructure 34 includes managing systems (MS) 50, collaboration tools (CT) 52, and non-infrastructural elements (NIE) 54, as non-limiting examples. Managing systems 50 are tools used to actually manage and/or operate the customer infrastructure. Some of these tools may require their own system and software infrastructure. For example, patch management tools often require a set of servers (e.g. staging servers, database servers) and software (e.g. agents) to perform their operations. Whether these tools should be in a redundant configuration depends on the tool function and operation. For instance, if the staging and database servers do not maintain critical state, new machines could potentially be configured and deployed if existing ones fail. Non-limiting examples of collaboration tools 52 used in the operation of processes include Lotus Notes® and Sametime®. Since inter/intra-team interaction is usually a critical dependency in processes, it is often preferable that such tools be deployed in a redundant configuration. Apart from the infrastructure, the operation of individual tools is preferably studied to determine if the tool performs remote operations that need to be atomic, but can be interrupted due to a failure. In such cases, resiliency may involve building transactional semantics (e.g. “soft commit”) into the tools.

Access to the customer, their infrastructure and tools (e.g. via an access interface 36) primarily requires ensuring the redundancy of the data and voice networks. Best practices in this domain can often be delegated to the network service providers that offer connectivity with redundancy and automatic failover built-in. Access may be evaluated end-to-end for a given process. In many cases, guarantees on redundant network connectivity may not be end-to-end. For example, a GDC handling a process for a remote customer may be connected to the customer infrastructure through another domestic location. While there may be a redundant network between the two locations, and also between the domestic location and the customer, the outage of the domestic location may break the connectivity. In this case, ensuring redundant connectivity involves ensuring that another intermediate location is available between the GDC and the customer. In ensuring resilient connectivity for a process, it is desirable to consider all the paths between its distributed role players, tools and infrastructure components. In contrast, by addressing resilient connectivity within a local context, one only ensures that individual delivery locations have redundant network connectivity to the customer and to other locations.

People and skills 38 availability is a natural and key aspect of process resiliency. Unavailability of resources with specific roles can adversely impact the performance of a process. Ensuring skills resiliency may be done formally by using a skills database that can be consulted to find and deploy personnel with similar skills, potentially available from another process or delivery location.

Delivery center facilities 40 naturally play a key role in the resiliency of processes. Site business continuity planning (BCP) may address these issues in a systematic and formal manner.

The data processing system 42 can be implemented using a computer or a computer program product (e.g. computer software), as non-limiting examples. As further non-limiting examples of an implementation utilizing a computer, one or more data processors may be employed either in a localized arrangement, a distributed arrangement connected by one or more networks, or a combination thereof.

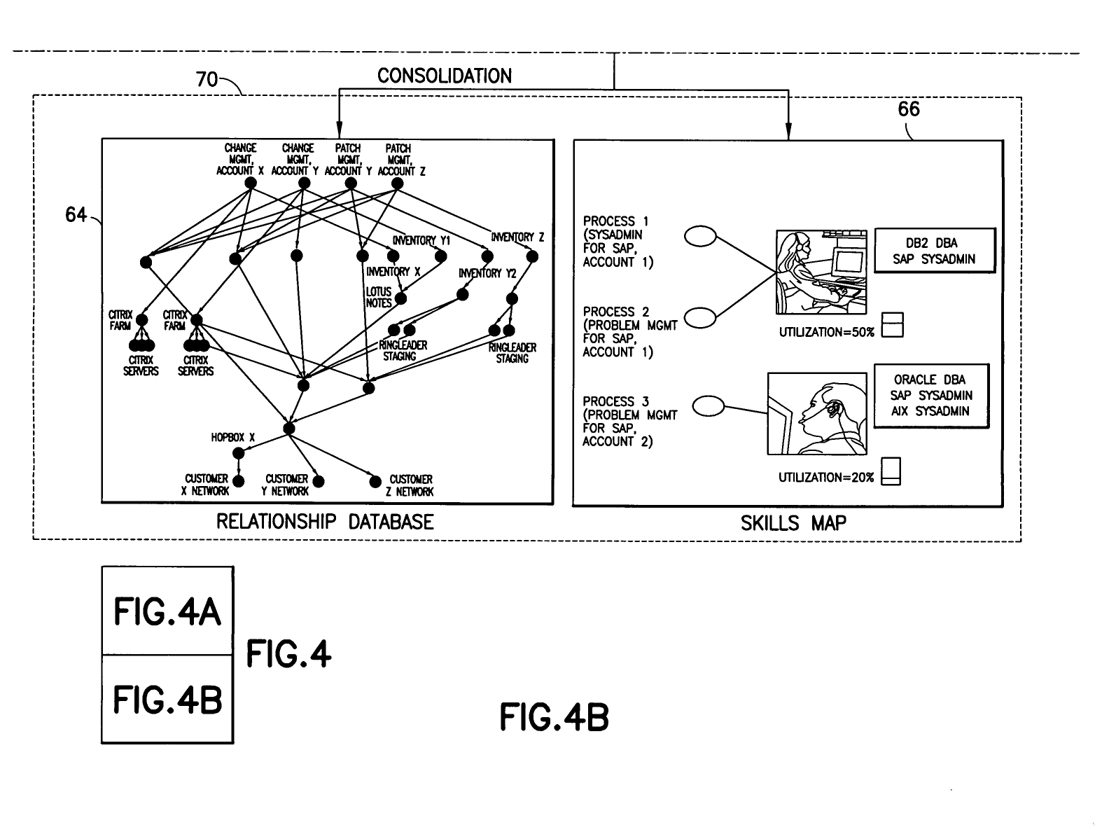

As individual processes are assessed for resiliency along these dimensions, one may incrementally build up a knowledge base for the delivery infrastructure, configuration and skills. As shown in FIG. 4, a web-based tool to create and query a process resiliency knowledge base may be provided to enable administrators to more easily populate the resiliency dependencies of their processes. Essentially, this allows them to create their BCP plans more systematically. The knowledge base populated by such a tool may be more amenable to processing for BCP consolidation and for redundancy planning, as compared to an unstructured document format that may be used more often.

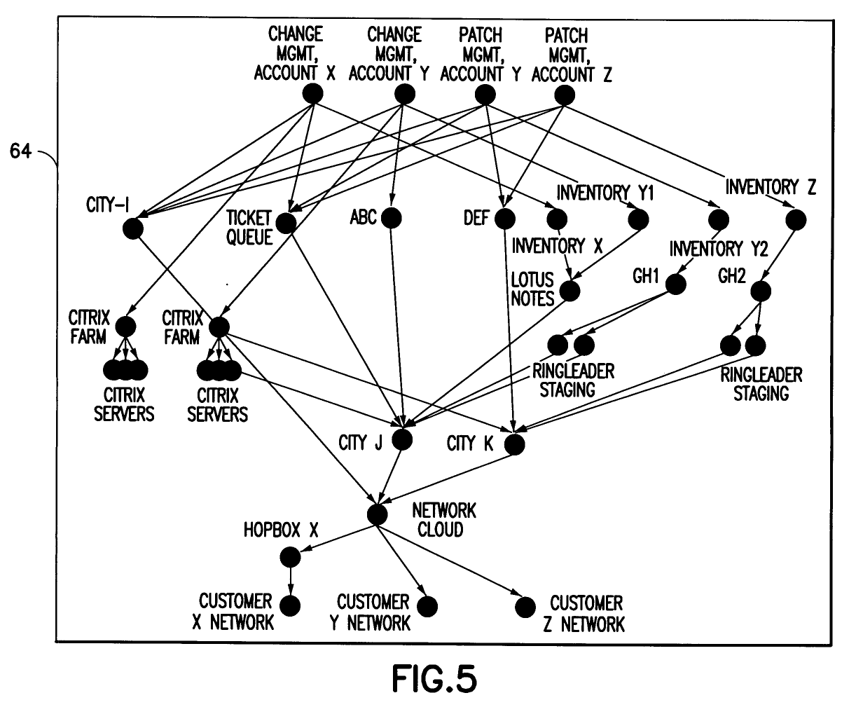

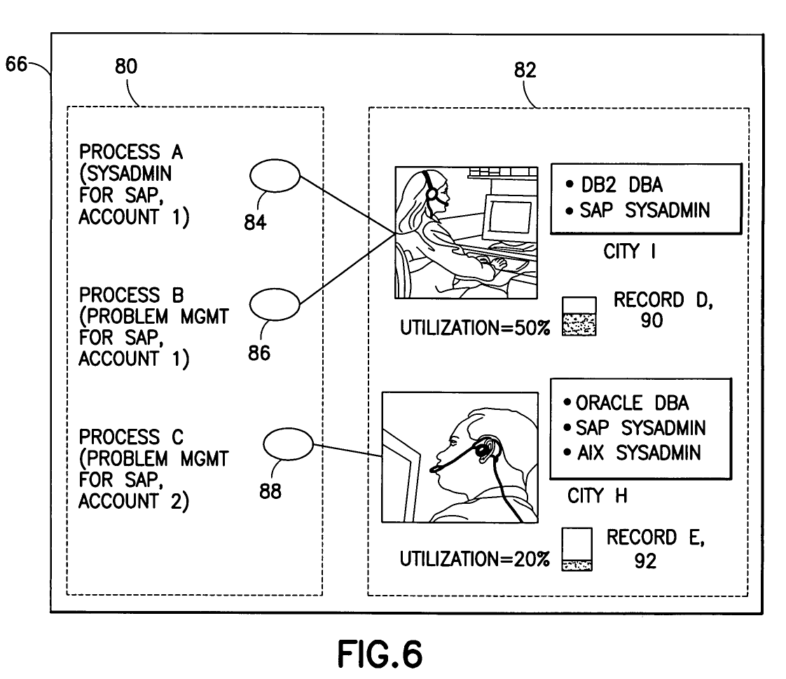

FIG. 4 illustrates an exemplary system 60 utilizing a web-based tool 62 in accordance with the exemplary embodiments of the invention. The web-based tool 62 is coupled to a dependency representation 64 and a skills map 66. The web-based tool 62 enables administrators 68 to create and/or query a process resiliency knowledge base 70. The process resiliency knowledge base 70 comprises and consolidates access to the dependency representation 64 and the skills map 66. In such a fashion, administrators 68 may readily have access to the process resiliency knowledge base 70 for either planning purposes (e.g. redundancy planning) or crisis management purposes (e.g. process management during an actual resource failure), as non-limiting examples. The dependency representation 64 is as shown in FIG. 5 and further described immediately below. The skills map 66 is as shown in FIG. 6 and further described below. Although shown in FIG. 4 as utilizing a web-based tool, other embodiments of the system may not use a web-based tool. Further embodiments of the system may utilize an internal tool, data or knowledge base, as non-limiting examples.

FIG. 5 depicts the dependency representation 64 of FIG. 4. The dependency representation 64 shows the relationships that exist as among the various resources involved in the delivery infrastructure of the exemplary system of FIG. 4. As is apparent, the delivery infrastructure of the system is complex, featuring a number of different resources. The resources depicted in the dependency representation 64 may take many forms including: services or processes (e.g. Change mgmt, Patch mgmt), systems (e.g. Citrix farm), programs (e.g. Lotus Notes®), physical collections (e.g. Inventory), persons and/or skill sets (e.g. management of resources) possibly indicated by location of the persons and/or skill sets (e.g. City I), networks (e.g. Network Cloud), and customers, as non-limiting examples. The various pathways engaged in the delivery of services and/or processes can be traced utilizing the dependency representation. In such a manner, perturbations to the model of the process can be considered, both in advance of and during an actual resource failure. In light of potential or actual perturbations, alternative available pathways can be considered and/or utilized to reduce the impact of the perturbations on the model and/or the process. A dependency representation may also be referred to as a delivery infrastructure knowledge base or a deployment configuration.

One aspect of ensuring end-to-end access resiliency resides in ensuring that redundant connections are in fact robust at all levels. For example, circuits from diverse network providers in a domestic network may appear to provide multiple backup paths in case of a failure on the primary path when viewed at the network or transport layer. However, these circuits may in fact share the same fiber link, making the fact that they are provided by different ISPs immaterial for the purpose of resiliency. Hence, it is important to consider even the physical layer topology when evaluating network resiliency.

Although backup paths may be available through alternate links to ensure connectivity in the event of a failure, service delivery may nonetheless be severely impacted if the backup capacity is underprovisioned. This may require careful planning of which network traffic (e.g. command center feeds, remote management of critical systems) should be entitled to use backup links when a failure occurs. Moreover, it may be desirable to have mechanisms in place to automatically enforce such prioritization.

The resiliency assessment methodology may place various requirements on the deployment of the tools and infrastructure utilized in service delivery. However, instead of meeting any such requirements on a case-by-case basis, it is preferable to cleanly distill them out into a best practices recommendation for tools and infrastructure deployment. Such a recommendation may rely on the knowledge base capturing the delivery infrastructure and configuration created as part of the resiliency assessment methodology. Given the knowledge base, the tool deployment is a planning problem that involves two steps: identifying the tools that need to be deployed in a redundant configuration, and deploying those tools according to various criteria, including resiliency, as a non-limiting example.

For existing tools, the first step is impact analysis. The “weight” (e.g. importance) of a tool is characterized by finding the set of processes dependent on the tool and the resiliency that is sought to be provided to these processes (e.g. processes with soft resiliency requirements, critical processes for which a stronger resiliency is more desirable). The resiliency of these tools can then be addressed in decreasing order of their weight. The goal of such a metric is to assess the potential business impact of process disruption due to the unavailability of the tool.

When planning for tool deployment based on resiliency criteria, various dimensions may be considered including planning for a redundant infrastructure for the tool (e.g. redundant servers, redundant databases) and planning for redundant access to the tool, as non-limiting examples. Planning a deployment according to such criteria is a combinatorial optimization problem. Given the structure and relationships expressed by the knowledge base, the placement of replicas can be guided by various optimization criteria such as the cost of deployment at various locations, balancing the number of tools deployed at any single location, availability of tool support staff and skills, and minimizing network latency to the managed systems, as non-limiting examples. The constraint that preferably should be satisfied while performing such optimization is that multiple paths exist to access the tool from any delivery location that is handling processes dependent on the tool.

Skills availability can be an important dependency for process resiliency. This area often has gaps in existing IT processes. These gaps are a result of not following a formal approach to ensure skills resiliency, which may involve formal planning during hiring, deploying and locating skills. For cases responding to skills unavailability that is not provisioned for in advance, this involves having access to a repository of the skills pool available at a given delivery location.

Skills resiliency is currently planned on a per-account basis. However, the scope of failures considered is usually local. Resiliency from an outage in a local location involves using the same set of people working from an alternate location. In specific account cases, an entire regional-level outage is handled by significantly smaller backup teams, which cannot (and are not designed to) provide full recovery of account operations. One alternative approach is to place redundant, lower-cost skills at regional and national levels in other GDCs at other locations. This approach may be beneficial in that it is potentially lower-cost and, due to the lower cost, it offers the possibility to plan for nearly full recovery of operations.

A skills database may be maintained by the local GDC. The form of the skills database may comprise an actual database, a spreadsheet or a document, as non-limiting examples. Each record in the database would contain various information referring to a person, his/her skill set expressed as a list of expertise areas, his/her current location (e.g. office location), and/or a utilization number, as non-limiting examples. Similarly, an account/process database may be maintained. The form of the account/process database may comprise an actual database, a spreadsheet or a document, as non-limiting examples. The current deployment of people to various accounts and/or processes can be expressed as a mapping from an account/process database to the skills database. Such a mapping preferably determines a utilization number for each person, based on the hours needed for each process. Schematically, the approach is illustrated in FIG. 6.

FIG. 6 depicts the skills map 66 of FIG. 4. The skills map 66 maps a process database 80 with a skills database 82. The process database 80 contains three entries corresponding to three processes: Process A 84, Process B 86, and Process C 88. The skills database 82 contains two records: Record D 90 and Record E 92. Each record comprises information concerning a person, his/her skill set expressed as a list of expertise areas, a utilization number, and a location. For example, Record D is for Person D and indicates that Person D has two skill sets relating to DB2 DBA and SAP sysadmin. Record D further indicates that Person D has a utilization of 50% and is located in City I. Record E contains similar information for Person E, indicating that Person E has three skill sets (Oracle DBA, SAP sysadmin, AIX sysadmin), a utilization of 20%, and is located in City H. In mapping the process database 80 with the skills database 82, the skills map 66 illustrates the current deployment of people to the various processes. Specifically, the skills map 66 indicates that Person D is currently deployed for Process A 84 and Process B 86 while Person E is currently deployed for Process C 88.

Based on the skills map data, it is possible to compute a skills resiliency plan for outages at the regional, local and national levels in a given geo. It is also possible to place (e.g. hire) skills optimally across the geo so that enough skill diversity exists across delivery locations. This computation can be performed through the application of well-known combinatorial optimization problem formulations.

Tools may be utilized to formalize skills resiliency. However, in the use and application of such tools, one should be aware that delivery skills have a much stronger dependence on actual field experience than on formal training such as coursework or certification. Hence, a tool in which the skill set is populated using formal training criteria is unlikely to reflect the true skills suitable for delivery. Some existing tools address this problem by using formal mechanisms that populate skills using, for instance, the history of a person's change/problem management process activity. They can also track the utilization of the skilled resources and their assignment to various accounts and processes, which is used by resource planning and scheduling tools. Such tools can be used for planning for skills availability in response to failures at the local, regional and national levels and also to locate and deploy skills in response to unplanned skills unavailability.

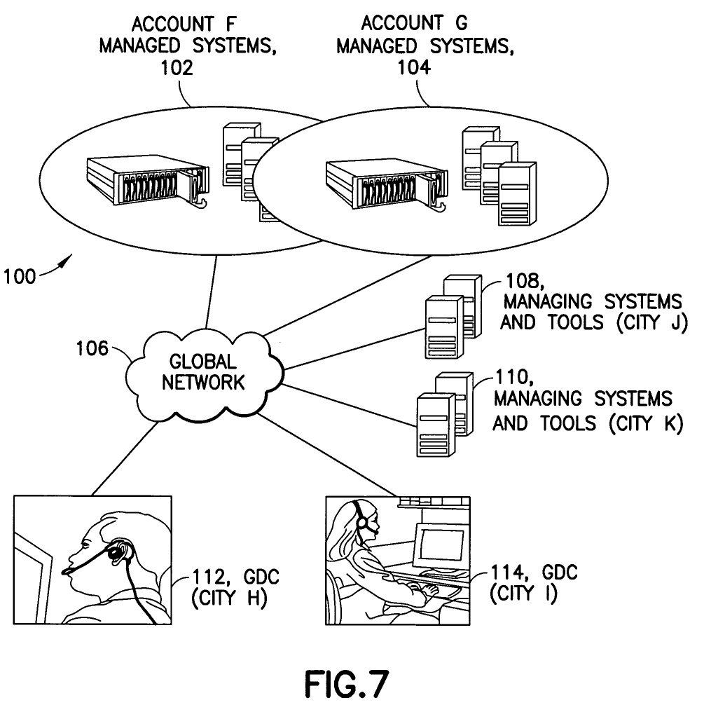

FIG. 7 depicts a model of a system 100 in accordance with the exemplary embodiments of the invention. Two managed systems 102, 104 are shown, Account F 102 and Account G 104. The managed systems 102, 104 are coupled to a global network 106. The model 100 includes two sets of managing systems and tools 108, 110 coupled to the global network 106. One set of the managing systems and tools is located in City J (“the City J managing systems” 108). The other set of managing systems and tools is located in City K (“the City K managing systems” 110). Both the City J managing systems 108 and the City K managing systems 110 can connect to the customer. As part of the planning proposed in conjunction with exemplary embodiments of the invention, a standby software and hardware infrastructure for the City K managing systems 110 exists in City J by means of the City J managing systems 108.

The model 100 further includes two global delivery centers (GDCs) 112, 114. One GDC is located in City H (“the City H GDC” 112). The other GDC is located in City I (“the City I GDC” 114). As part of the planning proposed in conjunction with exemplary embodiments of the invention, the City H GDC 112 can act as a standby delivery location with a redundant set of skills for the City I GDC 114. Note that Person D, corresponding to Record D 90 in FIG. 6, is located in the City I GDC 114 of FIG. 7. Person E, corresponding to Record E 92 in FIG. 6, is located in the City H GDC 112 of FIG. 7. This model 100 will be used in conjunction with the dependency representation 64 of FIG. 5 and the skills map 66 of FIG. 6 to further illustrate the implementation of exemplary embodiments of the invention.

When a failure occurs that falls into an identified failure mode, the response involves a sequence of recovery steps that has been planned in advance. In this section, examples will be presented illustrating how one can recover for unplanned/un-provisioned failures by exploiting the populated knowledge bases. Note that the sequence of steps is also representative of what a planned recovery would look like, except in that case, the knowledge bases would have been used in advance to plan the recovery steps.

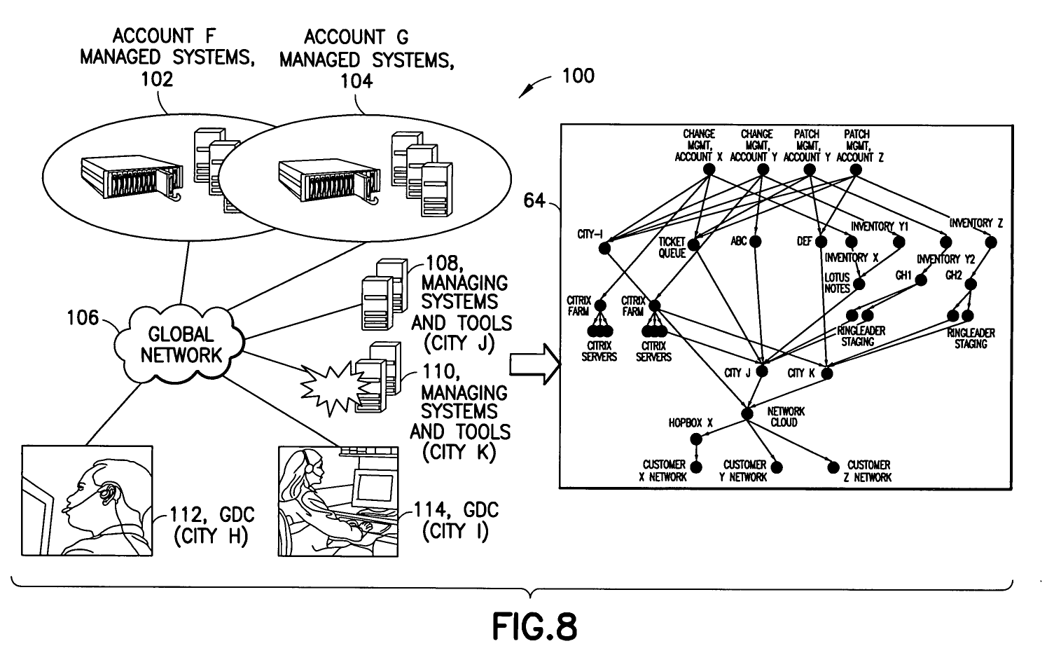

First, a scenario is presented in which a site hosting a managing system goes down. FIG. 8 depicts this scenario. Assume that the City K site (the City K managing systems 110) goes down and customer processes being served out of City I have to be resumed. As shown in FIG. 8, the model of the system 100 reflects the failure of the City K managing systems 110. The delivery infrastructure knowledge base 64 of FIG. 8 is utilized to derive the following sequence of steps. Consult the knowledge base 64 to find alternate tools servers in City J (the City J managing systems 108). Consult the knowledge base 64 to find the tool set that needs recovery (the City K managing systems 110). Activate the City J managing systems 108 using secure remote management tools. Setup streaming of managed system data to the City J managing systems 108 using secure remote management tools. Consult the knowledge base 64 to find an available GDC location that can reach City J (remains the same: the City I GDC 114). Tear down control/management connections from the City I GDC 114 to the City K managing systems 110 and establish control/management connections from the City I GDC 114 to the City J managing systems 108.

This sequence of steps recovers the customer processes in response to the City K outage. Note that the knowledge base 64 and planning were important inputs in enabling this recovery.

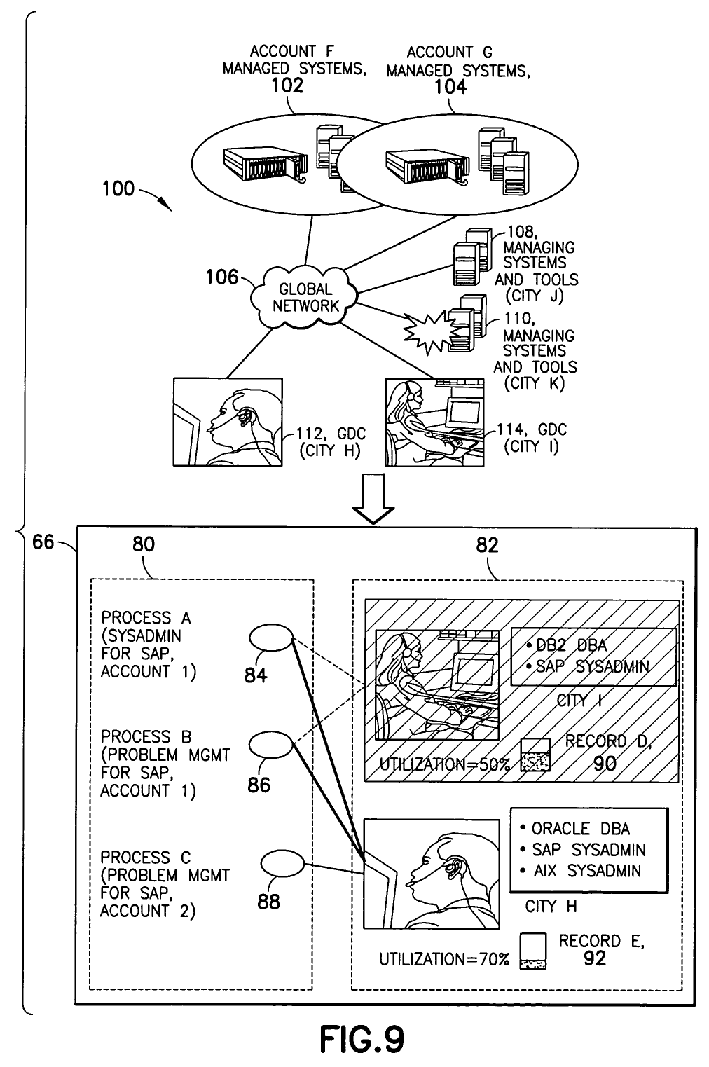

A second scenario is presented in which a skill set becomes unavailable. FIG. 9 illustrates the scenario wherein one of the GDC locations (the City I GDC 114) is no longer available due to an environmental event. In this case, as shown in FIG. 9, the managing systems 108, 110 for the two accounts 102, 104 use SAP as an application. For a City I GDC 114 outage, delivery for the accounts 102, 104 needs to be activated from another delivery center. A dependency representation (not shown) is consulted to determine that, from a connectivity point of view, at least the City H GDC 112 location can take over for the City I GDC 114. However, the critical criterion now becomes skills availability, and a GDC needs to be located which has skills available for use.

The skill required for the two processes is “SAP sysadmin”. The knowledge base is queried to determine that this skill set is available in the City H GDC 112. However, it must be determined whether this skill is available for use, based on City H GDC's current load. The utilization metric for the City H GDC 112 resources (Person E) is 20%, and can accommodate the additional account load from City I which has a utilization metric of 50%. This information is used to assign Process A 84 and Process B 86 to the City H staff (Person E) until City I recovers and Person D is once again available to cover Process A 84 and Process B 86.

Note that in general, sophisticated planning and scheduling tools are employed to execute this plan, and that the delivery infrastructure knowledge base and the skills database are important inputs in planning the response.

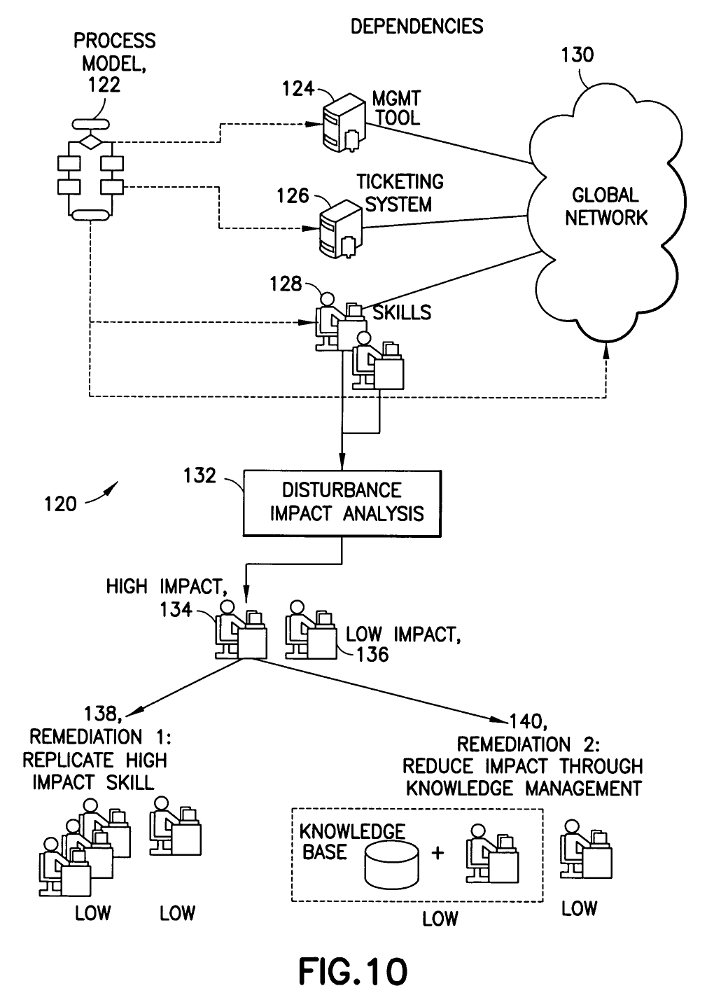

FIG. 10 provides an additional illustration 120 of the methodology employed in practicing the exemplary embodiments of the invention. A model 122 of an IT process is generated. The process includes a plurality of process steps. Resources associated with the process are identified. As shown in FIG. 10, the resources include a management tool 124, a ticketing system 126, and various skills 128, all of which are connected to a global network 130. For at least one process step, dependencies on the resources are identified. A disturbance impact analysis 132 is performed by perturbing the model 122 (e.g. at least one resource is degraded, at least one resource is made unavailable) and assessing the impact of the perturbation on the model 122. In FIG. 10, the assessment is performed by separating perturbations into two categories: those having a high impact 134 and those having a low impact 136. For the perturbations that have a high impact 134, the impact of the perturbation on the model 122 is reduced by utilizing at least one remedial action. As illustrated in FIG. 10, two remedial actions are employed. The first remedial action 138 is to replicate the resource (e.g. a skill set) that would otherwise cause a high impact in the face of perturbation. The second remedial action 140 is to use knowledge management (e.g. a knowledge base) to reduce the impact of the perturbation.

Although shown above using various graphs and pictures, the model generated may be a graphical representation or a non-graphical representation (e.g. a report). Similarly, the methodology employing the exemplary embodiments of the invention may utilize graphical elements or non-graphical elements in performing the steps of the method.

Generally, various exemplary embodiments of the invention can be implemented in different mediums, such as software, hardware, logic, special purpose circuits or any combination thereof. As a non-limiting example, some aspects may be implemented in software which may be run on a computing device, while other aspects may be implemented in hardware.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

Furthermore, some of the features of the preferred embodiments of this invention could be used to advantage without the corresponding use of other features. As such, the foregoing description should be considered as merely illustrative of the principles of the invention, and not in limitation thereof.

What is claimed is:

1. A method comprising:
generating a model of an information technology process, wherein the process comprises a plurality of process steps, wherein the model identifies resources associated with the process;
identifying dependencies on the resources for at least one process step of the plurality of process steps;
perturbing the model;
assessing an impact of the perturbation on the model; and
reducing the impact of the perturbation on the model by utilizing at least one remedial action.

2. The method of claim 1, wherein the process is modeled as a workflow.

3. The method of claim 1, further comprising an intermediary step of characterizing at least one normal operating range for the process in terms of at least one metric.

4. The method of claim 1, wherein the resources comprise at least one of infrastructure, other processes, people, and skill sets.

5. The method of claim 1, wherein perturbing the model comprises degrading at least one resource.

6. The method of claim 1, wherein perturbing the model comprises making at least one resource unavailable.

7. The method of claim 1, wherein the at least one remedial action comprises replicating at least one resource.

8. The method of claim 1, wherein the at least one remedial action comprises modifying the process.

9. The method of claim 1, wherein at least one of the steps is implemented on a computer system.

10. The method of claim 1, further comprising updating the model in response to reducing the impact of the perturbation on the model.

11. The method of claim 1, further comprising changing the process in response to reducing the impact of the perturbation on the model.

12. A computer program product comprising program instructions embodied on a tangible computer-readable medium, execution of the program instructions resulting in operations comprising:
generating a model of an information technology process, wherein the process comprises a plurality of process steps, wherein the model identifies resources associated with the process;
identifying dependencies on the resources for each process step of the plurality of process steps;
perturbing the model;
assessing an impact of the perturbation on the model; and
reducing the impact of the perturbation on the model by utilizing at least one remedial action.

13. The computer program product of claim 12, execution of the program instructions resulting in operations further comprising an intermediary step of characterizing at least one normal operating range for the process in terms of at least one metric.

14. The computer program product of claim 12, wherein the resources comprise at least one of infrastructure, other processes, people, and skill sets.

15. The computer program product of claim 12, wherein perturbing the model comprises degrading at least one resource.

16. The computer program product of claim 12, wherein perturbing the model comprises making at least one resource unavailable.

17. The computer program product of claim 12, wherein the at least one remedial action comprises replicating at least one resource.

18. The computer program product of claim 12, wherein the at least one remedial action comprises modifying the process.

19. The computer program product of claim 12, execution of the program instructions resulting in operations further comprising updating the model in response to reducing the impact of the perturbation on the model.

20. The computer program product of claim 12, execution of the program instructions resulting in operations further comprising changing the process in response to reducing the impact of the perturbation on the model.

21. A system comprising:
means for generating a model of an information technology process, wherein the process comprises a plurality of process steps, wherein the model identifies resources associated with the process;
means for identifying dependencies on the resources for each process step of the plurality of process steps;
means for perturbing the model;
means for assessing an impact of the perturbation on the model; and
means for reducing the impact of the perturbation on the model by utilizing at least one remedial action.

22. The system of claim 21, further comprising means for characterizing at least one normal operating range for the process in terms of at least one metric.

23. The system of claim 21, further comprising means for updating the model in response to reducing the impact of the perturbation on the model.

24. The system of claim 21, further comprising means for changing the process in response to reducing the impact of the perturbation on the model.

25. A method to improve information technology process resiliency comprising:
modeling an information technology process to develop a representation of the process;
creating a dependency representation from said representation;
conducting a sensitivity analysis based upon said dependency representation; and
planning at least one remedial action based upon the sensitivity analysis.

26. The method of claim 25, wherein the representation is a graphical representation.

27. The method of claim 25, wherein the representation comprises resources associated with the process.

28. The method of claim 25, further comprising updating the model in response to the sensitivity analysis.

29. The method of claim 25, further comprising changing the process in response to the sensitivity analysis.

30. A method to perform a sensitivity analysis on an information technology process comprising:
perturbing a model of the process; and
assessing an impact of the perturbation on the model.

31. The method of claim 30, further comprising reducing the impact of the perturbation on the model by utilizing at least one remedial action.

32. The method of claim 31, wherein the model comprises resources associated with the process and wherein the at least one remedial action comprises replicating at least one resource.

33. The method of claim 31, wherein the at least one remedial action comprises modifying the process.

34. The method of claim 30, further comprising updating the model in response to assessing the impact of the perturbation on the model.

35. The method of claim 30, further comprising changing the process in response to assessing the impact of the perturbation on the model.
